(19) United States
(12) Patent Application Publication
(10) Pub. No.: US 2016/0255856 A1
(43) Pub. Date: Sep. 8, 2016

(54) BEVERAGE POWDER

(71) Applicant: KRAFT FOODS R&D, INC., Deerfield, IL (US)

(72) Inventor: Nawaz Sulemanji, Madrid (ES)

(21) Appl. No.: 14/655,048

(22) PCT Filed: Jan. 29, 2015
(86) PCT No.: PCT/IB2015/000116

§ 371 Date: Jun. 23, 2015

(30) Foreign Application Priority Data
Feb. 26, 2014 (GB) 1403345.0

(51) Int. Cl. A23F 5/36; B65D 85/804; A47J 31/40; A23F 5/26

(52) U.S. Cl. CPC A23F 5/36; A23F 5/262; B65D 85/8043; A47J 31/407

(57) ABSTRACT

The present invention relates to a method for preparing a foaming beverage powder, the method comprising:
providing a porous beverage powder;
heating the porous beverage powder to a temperature below its glass transition temperature in a gas-containing atmosphere;
increasing the pressure of the gas-containing atmosphere to thereby raise the temperature of the porous beverage powder to a temperature above its glass transition temperature; and
then decreasing the pressure of the gas-containing atmosphere to thereby lower the temperature of the porous beverage powder to a temperature below its glass transition temperature.

This disclosure relates to a method of producing a foaming beverage powder. In particular, the disclosure relates to an instant coffee powder having a full rich flavour and a generous foam on the beverage when reconstituted.

Instant beverage ingredients are popular with consumers because they allow the ready reconstitution of a beverage at the consumer's convenience. Among such ingredients it is well known to produce instant coffee powders. These aim to simulate the experience of a beverage freshly prepared from coffee beans. However, there are a number of ways in which the reconstituted beverage may fail to match the fresh product.

Such products often lack the authentic flavour of a freshly prepared extract. There are a number of recent instant coffee products, both spray dried and freeze-dried, that are formed from a liquid coffee extract containing a small amount of roast and ground coffee (sometimes referred to as “microgrind”). It has been found that the inclusion of this roast and ground coffee provides a further depth of flavour. Indeed, soluble coffee beverages containing microground whole beans offer improved organoleptic properties for consumers, such as improved mouthfeel, and are positively perceived in the marketplace as being more related to ‘proper coffee’, i.e. freshly brewed roast and ground.

Soluble coffee products may also lack an authentic surface foam. To address this there are also a number of products that contain trapped gas in the pores of the coffee. On reconstitution of the coffee powder the trapped gas provides a crema or foam on the upper surface of the beverage. This improves the appearance and the mouthfeel of the beverage produced. There are several approaches to introducing foam into such a coffee. EP2194795 discloses a method of injecting gas into a liquid coffee extract before spray-drying to arrive at a spray dried coffee with entrapped gas. U.S. Pat. No. 7,534,461 discloses a method of heating a porous coffee powder in a sealed pre-pressurised container to trap gas in the pores of the coffee. Both of these documents are incorporated herein by reference.

US20060040033 discloses a non-carbohydrate forming composition and method of making the same.

Accordingly, it is desirable to provide an improved foaming beverage powder and/or tackle at least some of the problems associated with the prior art or, at least, to provide a commercially useful alternative thereto.

In a first aspect the present disclosure provides a method for preparing a foaming beverage powder, the method comprising:
providing a porous beverage powder;
heating the porous beverage powder to a temperature below its glass transition temperature in a gas-containing atmosphere;
increasing the pressure of the gas-containing atmosphere to thereby raise the temperature of the porous beverage powder to a temperature above its glass transition temperature; and
then decreasing the pressure of the gas-containing atmosphere to thereby lower the temperature of the porous beverage powder to a temperature below its glass transition temperature.

The present invention will now be further described. In the following passages different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

By a “beverage powder” it is meant an instant powder suitable for reconstitution with an aqueous beverage medium to provide a beverage or a portion of a beverage. That it, the beverage powder might be a soluble coffee powder suitable for alone providing a final beverage. On the other hand, the term also includes a powdered component suitable for inclusion in a blended beverage composition, such as a milk component of a hot chocolate blend, a creamer for use in a cappuccino and the like.

By beverage “powder” it is meant any particulate form of a dry beverage ingredient, such as granules or powder suitable for forming a beverage. It is well known to provide beverages in these forms, such as hot chocolate beverage mixes, spray-dried milk powders or freeze-dried coffee granules. Suitable powders would have an average longest diameter of from 10 to 1000 microns, more preferably from 100 to 500 microns.

By a “foaming” beverage powder it is meant a beverage powder (alone or in a blend) suitable for reconstitution with an aqueous beverage medium to provide a beverage having a foam on the surface thereof. The foam is produced by gas trapped in the foaming powder which is released on reconstitution. The gas is trapped in at least some, more preferably a majority of the closed pores at a pressure in excess of atmospheric pressure.

By a porous beverage powder it is meant a beverage powder having an expanded structure including one or more open or closed pores. Such beverage powders are well known in the art. For example, the starting materials used in WO2009/059938, incorporated herein by reference, would all be suitable for use in the method disclosed herein. The preferred beverage powder has a “foaming” porosity (as measured with mercury porosimetry or X-ray tomography) of at least 35%, more preferably at least 50% and most preferably from 60%-75%.

Foaming porosity is a measure of the porosity which contributes to foaming and characterises the potential foaming ability of the powder. Pores with opening diameter of less than 2 micrometres may also contribute to foam since the capillary pressure in these pores is greater than the ambient pressure and this may enable foam formation. The foaming porosity is obtained by including closed pores and open pores having an opening diameter of less than 2 micrometres.

The glass-liquid transition (or glass transition for short), Tg, is the reversible transition in amorphous materials from a hard and relatively brittle state into a molten or rubber-like state. The determination of Tg values is well known in the beverage industry and can easily be determined by simple experimentation for a given powder.

Where the powder contains two or more different components, these may have different Tg values. The method described herein requires only that one or more components of the beverage powder is raised above its Tg. In this way it can serve as a matrix for containing any other beverage components which are present.

As disclosed in U.S. Pat. No. 7,534,461, which is incorporated herein in its entirety by reference, it is known to trap gas in the pores of a spray dried coffee powder. This may be achieved by pressurising the powder with a suitable gas and then heating the powder above its Tg. In this way gas may become trapped in the pores of the coffee powder. The pressurisation is performed before heating and heating is performed with a heated oil jacket around the pressurised coffee container.

The present inventors have discovered that there are a number of drawbacks with the conventional process, especially for coffee. For example, the method leads to significant agglomeration of the particles and, accordingly, free flow agents (such as silicon dioxide) may need to be used to mitigate this. Furthermore, due to the slow heating changes that result from the use of heated oil jackets, the coffee is held at an elevated temperature for longer than would be desired: this causes agglomeration but also a degradation of the coffee flavour components (such as coffee aroma components). It was considered whether more powerful heating units could be used to control the temperature of the coffee. However, the faster heating/cooling of bulk amounts of coffee in this way would be prohibitively expensive.

The present inventors have instead discovered that it is possible to provide a quick increase and decrease in the temperature throughout a beverage powder bulk by changing the pressure in the process chamber. This temperature change can be made sharp and occurs evenly throughout the chamber. Specifically, the inventors have found that by heating a porous powder to close to its glass transition temperature (Tg) they can raise the temperature of the bulk powder over the Tg for a controlled amount of time and to a predetermined temperature, simply by increasing the pressure to a predetermined level. The pressure can then be fully or partially released to cause a sudden controlled drop in the bulk powder temperature to below the Tg.

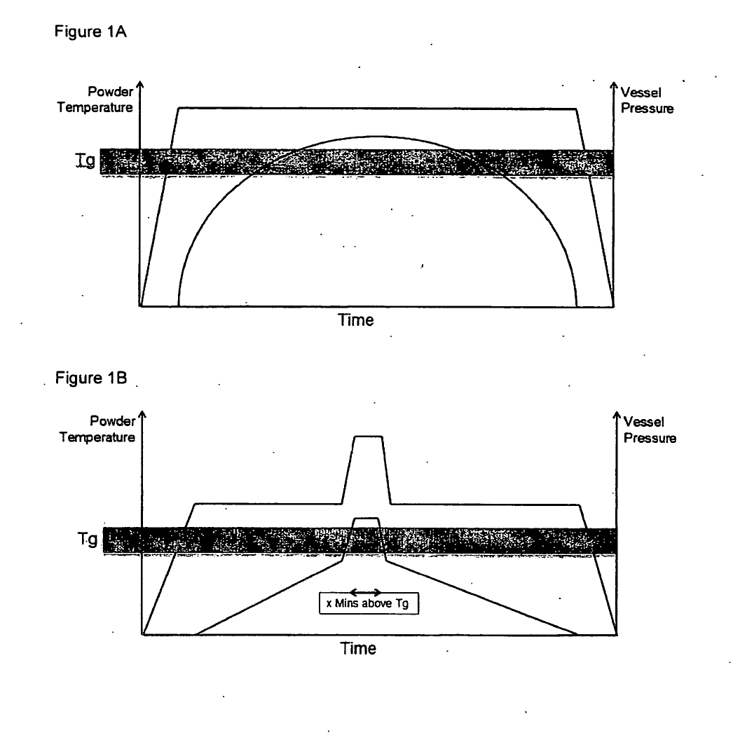

Due to the decreased time required at an elevated temperature it has been found that there is less degradation of flavour components in the beverage powder. This is especially the case for temperature sensitive instant coffee formulations and milk powders where maillards reactions can spoil the flavours. Furthermore, an increased foaming can be achieved since the temperature sufficient for gas entrapment can be held for longer, while still reducing the time at which the powder is above its Tg (see FIGS. 1A and 1B).

The process relies on volumetric heating which means that the temperature is increased through the increased gas temperature in the process chamber due to the increased pressure (and the same for cooling). Accordingly, the process is less dependent on convection and conduction through the walls of the treatment chamber. Without wishing to be bound by theory, because the heating is volumetric and evenly applied to the beverage powder, it is considered that the stresses are reduced and a greater volume of gases may be trapped because the pores are less prone to fracture. As a consequence, there may also be less undue caking and agglomeration of the powder. Caking is more likely to occur where the heating is less even, since hot-spots can form.

Preferably the method is carried out without the use of free-flow agents, also known as anti-caking agents. These are an additive placed in powdered or granulated materials to prevent the formation of lumps and for easing packaging, transport, and consumption and are well known in the art to reduce agglomeration when powders are heated. Free-flow agents and anti-caking agents include silicon dioxide, tricalcium phosphate, powdered cellulose, magnesium stearate, sodium bicarbonate, sodium ferrocyanide, potassium ferrocyanide, calcium ferrocyanide, bone phosphate, sodium silicate, calcium silicate, magnesium trisilicate, talcum powder, sodium aluminosilicate, potassium aluminium silicate, calcium aluminosilicate, bentonite, aluminium silicate, stearic acid, polydimethylsiloxane.

Advantageously, the process described herein can therefore be carried out without the need for additional ingredients and by a simpler, less-complex method. Moreover, because there is no need for the addition of any free-flow agent, there are no regulatory issues with referring to the product as a coffee—there are no additives required.

The beverage powder can be any carbohydrate and/or protein composition having a porous structure and capable of trapping pressurised gas in pores thereof. Advantageously, however, the method can be applied to most standard beverage ingredients, such that there does not need to be any additional matrix present in the powder to entrap the gas. Preferably the porous beverage powder is selected from soluble coffee, hot chocolate, maltodextrin, tea, creamer and milk powder. In particular, it is preferred that the porous beverage powder is an instant coffee powder, especially spray-dried coffee powder. Freeze-dried coffee powder could also be contemplated for use in this method, but is less preferred due to the larger open pores compared to spray dried coffee.

The soluble coffee beverage ingredient can contain finely ground roast and ground coffee, such as coffee having a particle size of from 5 to 80 microns, preferably from 10-15 microns. This coffee is preferably formed within the porous beverage powder and, therefore, does not act as a free-flow agent. When present it is preferably 5 to 20 wt % of the soluble coffee.

Preferably the heating of the porous beverage powder to a temperature below its glass transition temperature in a gas-containing atmosphere raises the temperature of the powder to within 20° C., preferably 10° C., more preferably within 5° C. of its glass transition temperature. Preferably the heating is to more than 1° C. below the glass transition temperature. The closer the powder is to the Tg before the pressure is increased, the lower the pressure increase required to raise the temperature above the Tg. It is more cost-effective to heat the powder than to use further elevated pressures and, accordingly, a close preheating is desirable. Nevertheless, lower temperatures are generally favoured to minimise general degradation of the flavours present in the powders.

Preferably the gas-containing atmosphere is selected from one or more of air, nitrogen and carbon dioxide. The use of nitrogen and/or carbon dioxide is especially preferred since this mitigates any oxidation or spoiling of the beverage powders.

Preferably the method further comprises a step of pre-pressurising the porous powder in the gas-containing atmosphere to a pressure of from 10 to 200 Bar, more preferably 20 to 150 Bar and more preferably 50 to 100 Bar. As will be appreciated, a relatively high final pressure is required in order to introduce the gas into the pores of the porous powder. Accordingly, the use of a pre-elevated pressure before the heating step means that the pressure increase required to increase the temperature and to result in sufficient pressure for gas-pore infiltration can be minimised.

Preferably the method is carried out in a chamber and wherein the pressure of the gas-containing atmosphere is increased by increasing the amount of gas in the chamber and/or by decreasing the volume of the chamber. Of these techniques, it is especially preferred that the amount of gas is increased. This avoids the risk of compaction and excess agglomeration, while being readily controllable.

Preferably the pressure is increased (and then decreased) by from 1 to 100 Bar, preferably from 10 to 50 Bar. This change in pressure is sufficient to change the temperature relative to the Tg of the powder. When the pressure is dropped after treatment, the temperature falls very quickly and the structure is effectively “quenched” with the pressurised gas trapped inside.

Preferably the pressure is held at the increased pressure for from 1 second to 15 minutes, preferably 10 seconds to 10 minutes, more preferably from 30 seconds to 5 minutes. This amount of time is required in order for the gas to fully infiltrate the pores of the porous powder. In contrast, the preferred time ranges disclosed in U.S. Pat. No. 7,534,461 are from 10 to 150 minutes and typically in the region of 30 minutes to one hour. This includes the time taken to raise the product to the treatment temperature and to allow it to cool afterwards. The present method allows for faster treatment and less degradation of the product.

Preferably the porous beverage powder provides a foaming level of at least 2 ml after one minute, more preferably from 3 to 6 ml after one minute. The extent to which a beverage powder foams can be measured by the quantitative in-cup foam test. This test measures the amount of foam generated by a composition upon re-constitution. In this method, 1.8 g of the composition being tested is weighed into a 100 cm³ cylindrical glass measuring cylinder of 25 mm diameter and 250 mm height at 20° C., and then 70 cm³ of water at 80° C. is poured onto it from a beaker through a funnel at the top of the measuring cylinder over a period of about 5 seconds. The funnel used consists of a conical section of base diameter 50 mm and height 40 mm, connected to a tubular section of internal diameter 5 mm and length 50 mm. The funnel controls the addition of water used to reconstitute the composition. The foam volumes generated by the composition upon reconstitution are noted at 1 and 10 minute time intervals. All measurements are carried out in duplicate.

Preferably the method further comprises the step of cooling the foaming beverage powder to room temperature and packaging it. The packaging may be conventional bulk instant coffee packaging such as a jar or pot or a refill bag. Alternatively, the packaging may be a beverage preparation capsule suitable for use in a beverage preparation machine. Such machines are well known and include, for example, the Tassimo™ machine.

The foaming beverage powder may also be subjected to milling, grinding or further treatments to adapt the size of the powder or the surface properties after the Processing and before the optional packaging. Preferably there are no such further treatments; this serves to avoid damaging the pore structure and the trapped gas. Furthermore, the powder may be blended with further ingredients to form a composite beverage powder suitable for the preparation of a beverage, such as a cappuccino, a white tea, a white coffee or a hot chocolate beverage mix.

According to a second aspect, there is provided a foaming beverage powder obtainable by the method disclosed herein. The foaming beverage powder obtainable by the present process may be distinguished from conventional foaming powders due to the high pressure trapped gas while the powder does not show the flavour degradation associated with conventional powders.

According to a third aspect, there is provided a method of preparing a beverage, the method comprising contacting the foaming beverage powder disclosed herein with an aqueous medium. Preferably the aqueous medium is milk or water. Preferably the aqueous medium is provided at a temperature of from 70 to 100° C., more preferably from 80 to 90° C.

According to a fourth aspect, there is provided a capsule for preparing a beverage, the capsule comprising an inlet for an aqueous beverage medium, an outlet for a beverage and a flowpath therebetween, said capsule further containing in the flowpath the foaming beverage powder disclosed herein.

According to a fifth aspect, there is provided a beverage preparation system for preparing a beverage, the system comprising means for providing an aqueous beverage medium to the capsule disclosed herein.

The invention will now be described in relation to the following non-limiting figures, in which:

FIG. 1A shows an exemplary plot representing the techniques of the prior art. The upper, angular line represents the vessel pressure. The lower curved line represents the change of temperature controlled by heating/cooling of the process chamber. The Tg is marked as a band across the plot.

FIG. 1B shows an exemplary plot representing the techniques disclosed herein. The upper, angular line represents the vessel pressure. This is increased in order to increase the temperature (hence the corresponding increase in the temperature plot). The lower line represents the change of temperature of the process chamber. The Tg is marked as a band across the plot.

It should be noted that FIGS. 1A and 1B are only representations of the expected temperature and pressure a given sample. There is no scale provided in the figures. It is noted that the relative heights and widths of the Tg band differ in the figures. However, the Tg of a given material is constant.

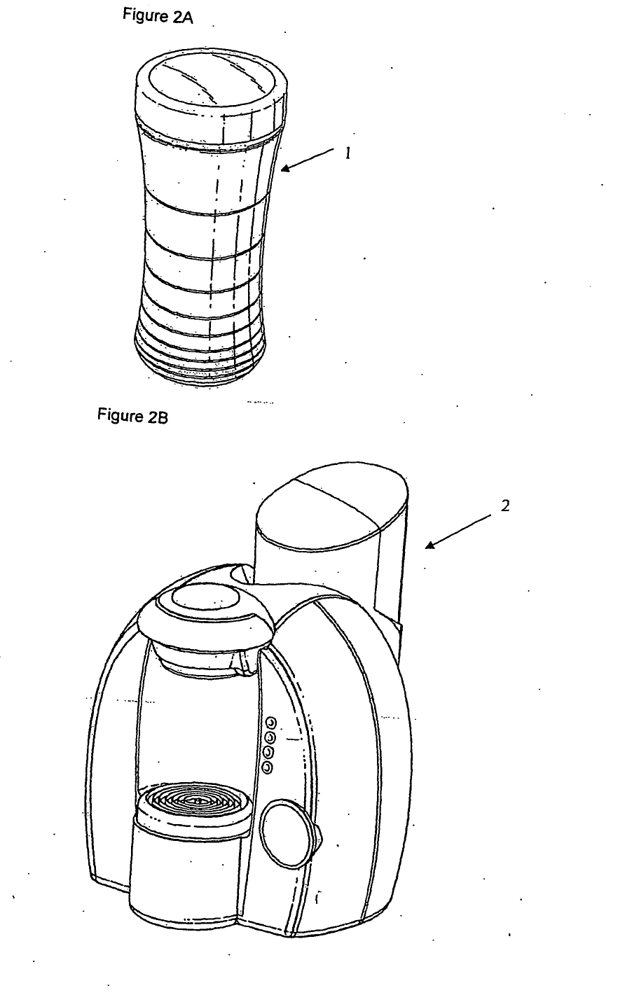

FIG. 2A shows a container 1, suitable for holding an instant coffee composition as disclosed herein.

FIG. 2B shows a coffee beverage preparation system.

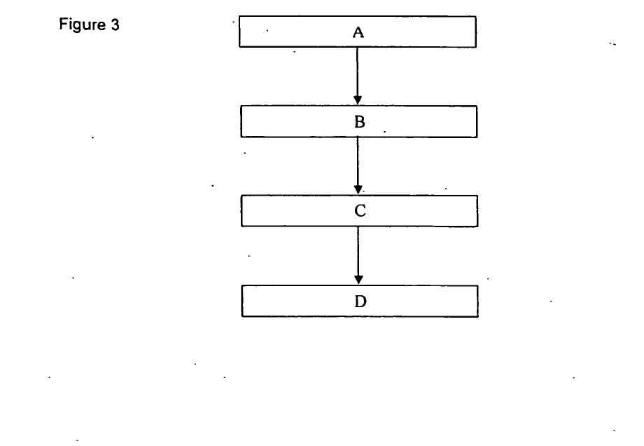

FIG. 3 is a flow chart of the key steps of the process. In step A, a porous beverage powder is provided. In step B, this powder is heated to a temperature below its glass transition temperature in a gas-containing atmosphere. In step C the pressure is increased to thereby raise the temperature of the porous beverage powder to a temperature above its glass transition temperature. In step D, the pressure is then decreased to thereby lower the temperature of the porous beverage powder to a temperature below its glass transition temperature.

The invention will now be described in relation to the following non-limiting examples.

### EXAMPLE

1 Kg of spray dried coffee powder with a moisture content of 3.5% and a glass transition temperature of 80° C. was placed in a tumbling high pressure vessel with an oil heated jacket on the outside. The vessel was pressurised to 60 Bar with Nitrogen and then the oil jacket was set to 75° C. The powder was heated through conduction of the oil jacket through the walls of the tumbling pressure vessel at a rate of 3.5° C./min. The vessel was heated until the contents were at a temperature of 75° C.

The vessel was then further pressurised to 90 Bar. This rapid pressurisation caused the powder temperature to change instantaneously from 75° C. to 85° C. This is over the glass transition temperature of this specific powder and the conditioned needed for the high pressure gas to seep into the pores of the spray dried particles. The powder was held for 5 minutes at this temperature and then the pressure was dropped on the vessel to 40 Bar. This rapid depressurisation caused the powder temperature to fall instantaneously from 85° C. to 70° C. a temperature below its glass transition.

The oil heater was then set to 20° C. and the powder cooled at a rate of 1° C./min till it reached 30° C. The vessel was then depressurised to atmospheric pressure and the vessel unloaded. The resulting spray dried powder came out of the vessel and had high pressure gas trapped inside its gas tight voids.

When compared to the base spray dried powder it gave 8 times as much gas release when made up with hot water. The powder also came out with 85% a free flowing powder bellow 500 microns. The agglomerates that remain were soft agglomerates and could be ground down to powder whilst still retaining their foaming potential. This optimization of good process yields of free flowing powder and good gas entrapment was only possible due to the controlled period the powder was exposed to temperatures above its glass transition temperature.

Although preferred embodiments of the invention have been described herein in detail, it will be understood by those skilled in the art that variations may be made thereto without departing from the scope of the invention or of the appended claims.

1. A method for preparing a foaming beverage powder, the method comprising:
providing a porous beverage powder;
heating the porous beverage powder to a temperature below its glass transition temperature in a gas-containing atmosphere;
increasing the pressure of the gas-containing atmosphere to thereby raise the temperature of the porous beverage powder to a temperature above its glass transition temperature; and
then decreasing the pressure of the gas-containing atmosphere to thereby lower the temperature of the porous beverage powder to a temperature below its glass transition temperature.

2. The method according to claim 1, wherein the porous beverage powder is selected from soluble coffee, hot chocolate, maltodextrin, tea, creamer and milk powder.

3. The method according to claim 1 or claim 2, wherein the porous beverage powder is a spray-dried coffee powder.

4. The method according to any of the preceding claims, wherein the heating of the porous beverage powder to a temperature below its glass transition temperature in a gas-containing atmosphere raises the temperature of the powder to within 20° C., preferably 10° C. of its glass transition temperature.

5. The method according to any of the preceding claims, wherein the gas-containing atmosphere is selected from one or more of air, nitrogen and carbon dioxide.

6. The method according to any of the preceding claims, wherein the method further comprises a step of pre-pressurising the porous powder in the gas-containing atmosphere to a pressure of from 10 to 100 Bar.

7. The method according to any of the preceding claims, wherein the method is carried out in a chamber and wherein the pressure of the gas-containing atmosphere is increased by increasing the amount of gas in the chamber and/or by decreasing the volume of the chamber.

8. The method according to any of the preceding claims, wherein the pressure is increased by from 1 to 100 Bar, preferably from 10 to 50 Bar.

9. The method according to any of the preceding claims, wherein the pressure is held at the increased pressure for from 10 seconds to 10 minutes.

10. The method according to any of the preceding claims, wherein the porous beverage powder provides a foaming level of at least 2 ml after one minute.

11. The method according to any of the preceding claims, wherein the method is carried out without the use of free-flow agents.

12. The method according to any of the preceding claims, wherein the method further comprises the step of cooling the foaming beverage powder to room temperature and packaging it.

13. A foaming beverage powder obtainable by the method of any of the preceding claims.

14. A method of preparing a beverage, the method comprising contacting the foaming beverage powder of claim 12, or produced according to the method of any of claims 1 to 11, with an aqueous medium.

15. A capsule for preparing a beverage, the capsule comprising an inlet for an aqueous beverage medium, an outlet for a beverage and a flowpath therebetween, said capsule further containing in the flowpath the foaming beverage powder of claim 13, or produced according to the method of any of claims 1 to 12.

16. A beverage preparation system for preparing a beverage according to claim 14, the system comprising means for providing an aqueous beverage medium to the capsule of claim 15.
